(19) United States
(12) Patent Application Publication
(10) Pub. No.: US 2018/0272489 A1
(43) Pub. Date: Sep. 27, 2018

(54) ADJUSTABLE AUTOMATIC DISPENSING APPARATUS

(71) Applicants: Jason M. HUDKINS, Rochester, IN (US); Brendan HUDKINS, Rochester, IN (US)

(72) Inventors: Jason M. HUDKINS, Rochester, IN (US); Brendan HUDKINS, Rochester, IN (US)

(21) Appl. No.: 15/924,642

(22) Filed: Mar. 19, 2018

Related U.S. Application Data
(60) Provisional application No. 62/474,363, filed on Mar. 21, 2017.

(51) Int. Cl. B23Q 11/12; B23Q 11/14; G05B 19/042

(52) U.S. Cl. CPC B23Q 11/122; B23Q 11/124; B23Q 11/125; G05B 2219/23377; G05B 19/042; G05B 2219/2618; B23Q 11/14

(57) ABSTRACT

An adjustable automatic fluid dispensing apparatus includes one or more inlets for receiving fluid or fluids to be mixed and dispensed. A flow sensor is provided in flow communication with the inlet for sensing the amount of fluid that is passing through the apparatus. A solenoid valve is in flow communication with the inlet and flow sensor for controlling the flow amount of fluid to be dispensed. An outlet is utilized in flow communication with the inlet and flow sensor for dispensing fluid out of the apparatus into a bucket or machine reservoir. A programmable control unit is utilized for adjustably controlling any mixing of the fluids, the flow sensor and solenoid valve to dispense a desired settable amount of the fluid from the apparatus.

### BACKGROUND OF THE INVENTION

The present invention relates to the controlled dispensing of fluids to avoid spillage of the fluids thereby eliminating work shut down time, massive contamination and extensive time consuming clean up. More particularly, the present invention relates to adjustable automatic dispensing apparatus for a variety of industrial fluids that will insure no spillage or over filling of the fluids to be dispensed.

This invention will be explained in the context of cooling and lubricating fluids used in CNC machining. There are many other applications of the dispensing apparatus of the present invention that will be explained later.

Computer numerical control (CNC) is the automation of machine tools by means of computers executing pre-programmed sequences of machine control commands. This is in contrast to machines that are manually controlled by hand wheels or levers, or mechanically automated by cams alone. In modern CNC systems, the design of a mechanical part and its manufacturing program is highly automated. The part's mechanical dimensions are defined using computer-aided design (CAD) software, and then translated into manufacturing directives by computer-aided manufacturing (CAM) software. The resulting directives are transformed (by “post processor” software) into the specific commands necessary for a particular machine to produce the component, and then loaded into the CNC machine.

Since any particular component might require the use of a number of different tools—drills, saws, etc.—modern machines often combine multiple tools into a single “cell”. In other installations, a number of different machines are used with an external controller and human or robotic operators that move the component from machine to machine. In either case, the series of steps needed to produce any part is highly automated and produces a part that closely matches the original CAD design.

Motion is controlled along multiple axes, normally at least two (X and Y), and a tool spindle that moves in the Z (depth). The position of the tool is driven by direct-drive stepper motors or servo motors in order to provide highly accurate movements, or in older designs, motors through a series of step down gears. Open-loop control works as long as the forces are kept small enough and speeds are not too great. On commercial metalworking machines, closed loop controls are standard and required in order to provide the accuracy, speed, and repeatability demanded.

As the controller hardware evolved, the mills themselves also evolved. One change has been to enclose the entire mechanism in a large box as a safety measure, often with additional safety interlocks to ensure the operator is far enough from the working piece for safe operation. Most new CNC systems built today are 100% electronically controlled.

CNC-like systems are now used for any process that can be described as a series of movements and operations. These include laser cutting, welding, friction stir welding, ultrasonic welding, flame and plasma cutting, bending, spinning, hole-punching, pinning, gluing, fabric cutting, sewing, tape and fiber placement, routing, picking and placing, and sawing.

Cutting fluid is a type of coolant and lubricant designed specifically for metalworking processes, such as machining and stamping. There are various kinds of cutting and cooling fluids, which include oils, oil-water emulsions, pastes, gels, aerosols (mists), and air or other gases. They may be made from petroleum distillates, animal fats, plant oils, water and air, or other raw ingredients. Depending on context and on which type of cutting fluid is being considered, it may be referred to as cutting fluid, cutting oil, cutting compound, coolant, or lubricant. Most metalworking and machining processes can benefit from the use of cutting fluid, depending on workpiece material. Common exceptions to this are cast iron and brass, which may be machined dry (though this is not true of all brasses, and any machining of brass will likely benefit from the presence of a cutting fluid).

The properties that are sought after in a good cutting fluid are the ability to keep the workpiece at a stable temperature (critical when working to close tolerances). Very warm is acceptable, but extremely hot or alternating hot-and-cold are avoided. Maximizing the life of the cutting tip by lubricating the working edge and reducing tip welding is also important. Ensuring the safety for the people handling it (toxicity, bacteria, fungi) and for the environment upon disposal are also considerations. Preventing rust on machine parts and cutters is also a concern.

Every conceivable method of applying cutting fluid loaded into a cutting machine sump (e.g., flooding, spraying, dripping, misting, brushing) can be used, with the best choice depending on the application and the equipment available. For many metal cutting applications the ideal has long been high-pressure, high-volume pumping to force a stream of liquid (usually an oil-water emulsion) directly into the tool-chip interface, with walls around the machine to contain the splatter and a sump to catch, filter, and recirculate the fluid.

Cutting fluids degrade over time due to contaminants entering the lubrication system. A common type of degradation is the formation of tramp oil, also known as sump oil, which is unwanted oil that has mixed with cutting fluid. It originates as lubrication oil that seeps out from the slideways and washes into the coolant mixture, as the protective film with which a steel supplier coats bar stock to prevent rusting, or as hydraulic oil leaks. In extreme cases it can be seen as a film or skin on the surface of the coolant or as floating drops of oil. Skimmers are used to separate the tramp oil from the coolant. These are typically slowly rotating vertical discs that are partially submerged below the coolant level in the main reservoir. As the disc rotates the tramp oil clings to each side of the disc to be scraped off by two wipers, before the disc passes back through the coolant. The wipers are in the form of a channel that then redirects the tramp oil to a container where it is collected for disposal. Floating weir skimmers are also used in these situation where temperature or the amount of oil on the water becomes excessive.

Cutting fluids (or cooling and lubricating fluids) must be added to reservoirs in the CNC machines in the range of twenty gallons at a time. The cutting fluids may be contained in fifty-five (55) gallon drums or larger two hundred seventy-five to three hundred thirty (275-330) gallon totes. The drums or totes may be located near the CNC machines or may be centrally located in a storage room from which the fluid is plumed out to a location where the fluids are needed.

Dedicated care of dispensing the fluids from the storage containers into receptacles for later loading into the reservoirs or sumps of the machines is an absolute requirement for machine operators. While this effort is not complicated, the machinists have complicated control duties with loading raw material to be machined, running the CNC machines, and unloading the machined finished product, and repeating these tasks throughout their day.

The machinist typically places a bucket (suitably a 20 gallon bucket) below a manually controlled valve or spigot that will dispense the fluid into the bucket and then transferred to the CNC machine reservoir or sump and eventually into the work space. The bucket filling process is slow. If the machinist is extremely busy with the machining processes, it is easy for him or her to neglect the filling of the bucket which results in small to large spills which are very problematic to the safe working environment within the shop which requires the machinists to walk around the area. With slippery fluids on the floor, people can easily slip and fall injuring themselves and often requiring time off work to recooperate along with dealing with the work shut down time, massive contamination and massive time consuming clean up.

There is a need for an adjustable automatic dispensing apparatus that will prepare and adjustably automatically dispense the correct amount of cutting fluid into a bucket or CNC sump and then shut itself off without requiring constant oversite by the machinist.

### SUMMARY OF THE INVENTION

An adjustable automatic fluid dispensing apparatus includes one or more inlets for receiving fluid or fluids to be mixed and dispensed. A flow sensor is provided in flow communication with the inlet for sensing the amount of fluid that is passing through the apparatus. A solenoid valve is in flow communication with the inlet and flow sensor for controlling the flow amount of fluid to be dispensed. An outlet is utilized in flow communication with the inlet and flow sensor for dispensing fluid out of the apparatus into a bucket or machine reservoir. A programmable control unit is utilized for adjustably controlling any mixing of the fluids, the flow sensor and solenoid valve to dispense a desired settable amount of the fluid from the apparatus.

A principal object and advantage of the present invention is that the apparatus only dispenses the desired amount of mixed fluid required to be dispensed as the apparatus shuts itself off when the measured amount of fluid has been dispensed.

Another object and advantage of the present invention is that the apparatus may have multiple paralleled inputs as to mixed two or more fluids to a desired ratio necessary for a particular machine application.

Another object and advantage of the present invention is that the apparatus avoids spillage of the fluids thereby eliminating work shut down time, massive contamination, work place injuries and extensive time consuming clean up.

Another object and advantage of the present invention is that the apparatus allows operators to focus on their duties and not require them to earnestly watch the dispensing process which is now automated by the dispenser or apparatus.

### BRIEF DESCRIPTION OF THE DRAWINGS

FIG. 1 is front elevational view of the first embodiment of the invention defined as a pressurized adjustable automatic mixing and dispensing apparatus;

FIG. 2 is front elevational view of the first embodiment of the invention defined as a barrel-mounted pressurized adjustable automatic dispensing apparatus connected to a CNC machine;

FIG. 3 is front elevational view of the first embodiment of the invention defined as a barrel mounted pressurized adjustable automatic dispensing apparatus capable of dispensing into a bucket;

FIG. 4 is schematic view of the working components of the first embodiment of FIGS. 1-3;

FIG. 5 is a flow chart of operation of the working components of the first embodiment of the invention defined as a barrel-mounted pressurized adjustable automatic dispensing apparatus;

FIG. 6 is an enlarged front elevational view of the touch screen control panel of the second embodiment showing pre-programed dispensing applications;

FIG. 7 is front elevational view of a second embodiment of the invention defined as a remote delivery or barrel-mounted pressurized adjustable automatic dispensing apparatus;

FIG. 8 is schematic view of the working components of the second embodiment of FIGS. 7-12;

FIG. 9 is front elevational view of the second embodiment of the invention defined as two remotely fed pressurized adjustable automatic dispensing apparati connected to two CNC machines;

FIG. 10 is front elevational view of the second embodiment of the invention defined as a barrel-mounted pressurized adjustable automatic dispensing apparatus for pre-mixed fluids to be dispensed;

FIG. 11 is front elevational view of the second embodiment of the invention defined as a barrel-mounted and remotely fed pressurized adjustable automatic dispensing apparatus for mixing fluids to be dispensed; and

FIG. 12 is a flow chart of operation of the working components of the second embodiment of the invention defined as a pressurized adjustable automatic dispensing apparatus;

### DETAILED DESCRIPTION

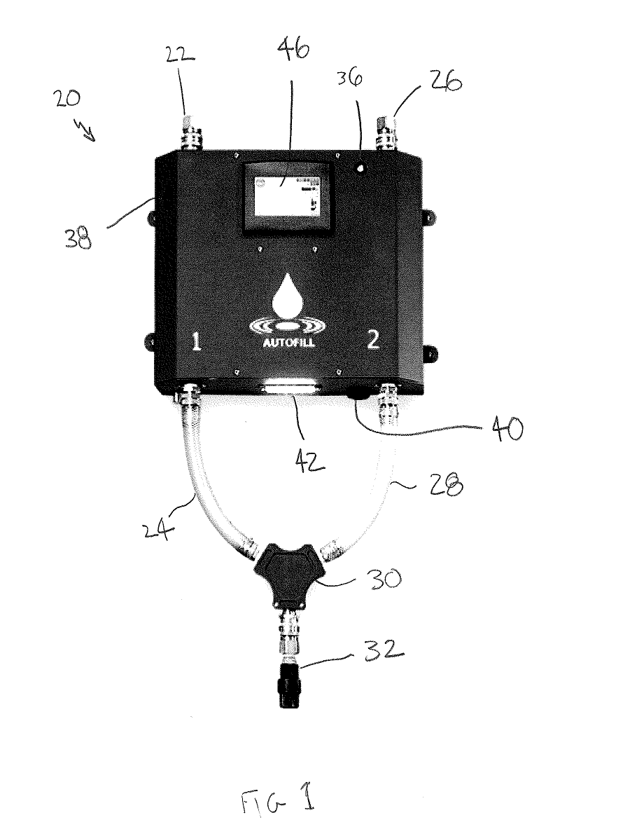

Referring to FIGS. 1-6 the first embodiment defined as a pressurized adjustable automatic mixing and dispensing apparatus or dispenser 20. The apparatus 20 has a lubrication concentrate (cutting oil or fluid) input 22, a lubrication concentrate output 24, a water input 26 and a water output 28. A mixing manifold 30 is provided below the concentrate output 24 and the water output 28 to mix the solutions (concentrate and water) together in the mixing manifold 30 from which the mixed fluid is fed into dispenser output 32 and further into a bucket 9 or reservoir sump 8 via a hose 7. The dispenser unit 20 has a power up button 36 and an external power outlet 38 for an external concentrate self-priming pump 3 mounted on the concentrate drum 2. A concentrate empty buzzer 40 is located on the dispenser 20 to indicate when the concentrate barrel 2 is empty, as known by the control 46 from past usage. The dispenser 20 is controlled by the touch screen control 46 which is programed and further programmable by its touch screen control 46. A bucket light 42 is also provided to be illuminated when the dispenser 20 is filling a bucket 9.

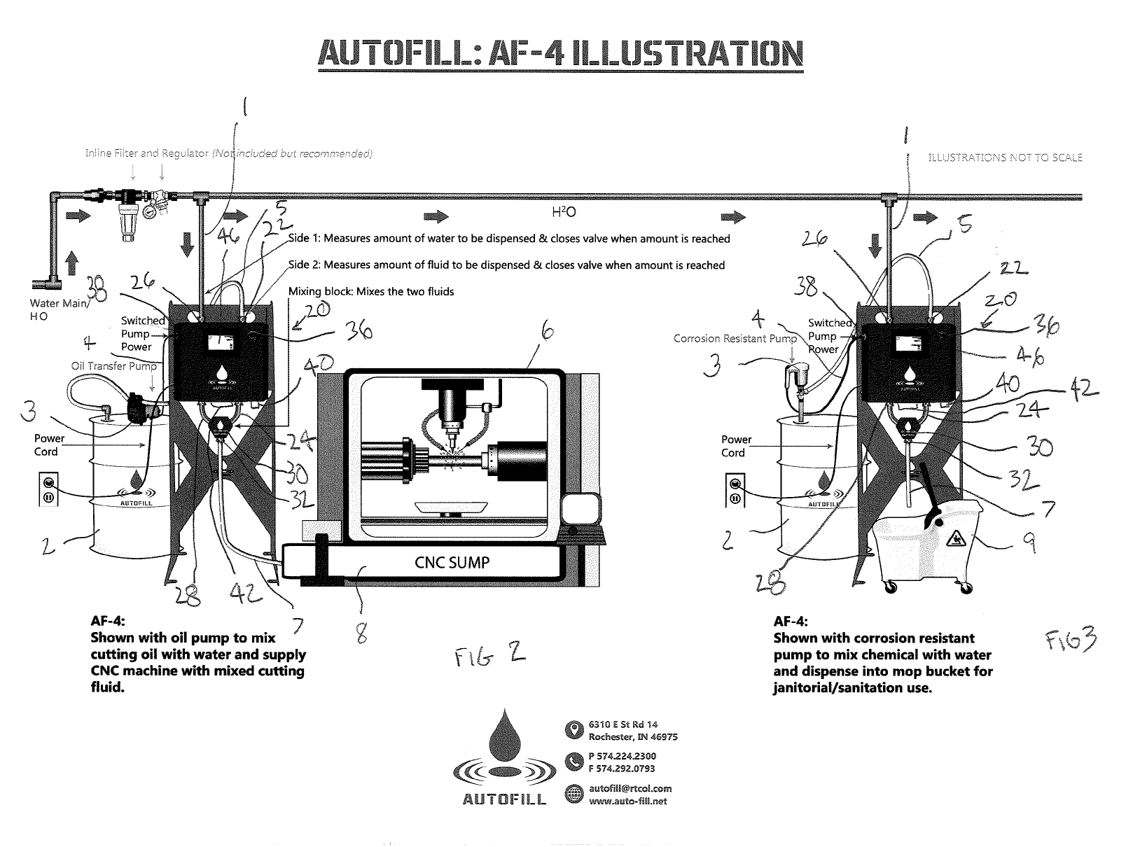

FIG. 2 illustrates the use of the dispenser 20 with a water input 1 and a pressurized concentrate input 5. The water is simply pressurized water from any source such as city or a well which feeds into water input 26 into the dispenser 20. The concentrated cutting oil is sourced from drum 2 which has an oil self-priming transfer pump 3 which pumps cutting oil out of the drum 2 and into concentrate input 22 into the dispenser 20. The touch screen control 46 allows the operator to set the volume of the mixed cutting and cooling fluid at a certain desired ratio. Viewing the concentrate side of the dispenser 20 from the inside of the dispenser 20 (FIG. 4) a concentrate conduit 50 receives the concentrate and the volume is controlled by the open and closed solenoid valve 52 under the control of the touch screen control 46 which receives the volume passing through the dispenser 20 from the flow meter 54. Viewing the water side of the dispenser 20 from the inside of the dispenser 20 (FIG. 4) a water conduit 60 receives the water and the volume is controlled by the open and closed solenoid valve 62 under the control of the touch screen control 46 which receives the volume passing through the dispenser 20 from the flow meter 64. Two fluids exit the dispenser through concentrate output 24 and water output 28 into mixing manifold 30 and then through hose 7 into machine 6 sump 8 for use by the CNC machine 6 in premeasured volume and concentrate.

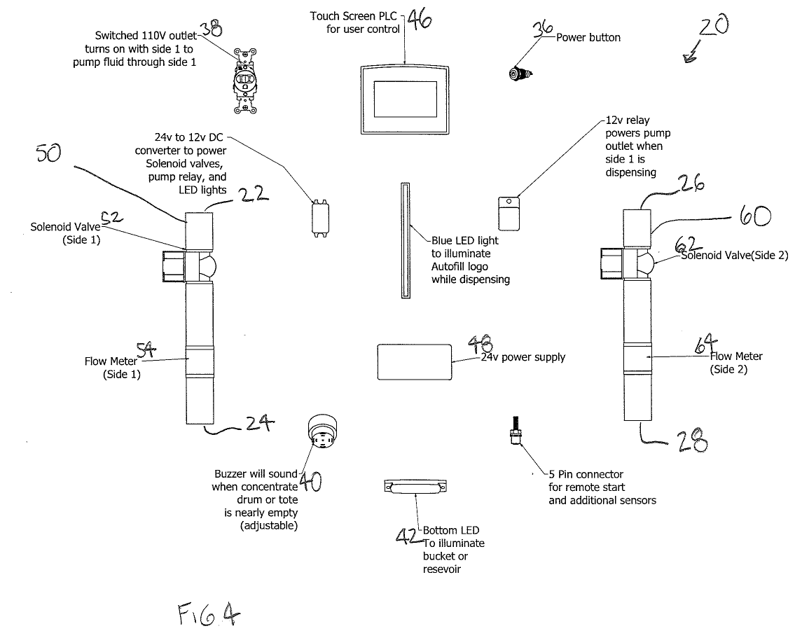

FIG. 3 illustrates the use of the dispenser 20 with water input 1 and a pressurized concentrate input 5. The water is simply pressurized water from any source such as city or a well which feeds into water input 26 into the dispenser 20. The concentrated cutting oil is sourced from drum 2 which has an oil pressurizing transfer pump 3 which pumps cutting oil out of the drum 2 and into concentrate input 22 into the dispenser 20. The touch screen control 46 allows the operator to set the volume of the mixed cutting and cooling fluid at a certain desired ratio. Viewing the concentrate side of the dispenser 20 from the inside of the dispenser 20 (FIG. 4) a concentrate conduit 50 receives the concentrate and the volume is controlled by the open and closed solenoid valve 52 under the control of the touch screen control 46 which receives the volume passing information through the dispenser 20 from the flow meter 54. Viewing the water side of the dispenser 20 from the inside of the dispenser 20 (FIG. 4) a water conduit 60 receives the water and the volume is controlled by the open and closed solenoid valve 62 under the control of the touch screen control 46 which receives the volume passing information through the dispenser 20 from the flow meter 64. Two fluids exit the dispenser through concentrate output 24 and water output 28 into mixing manifold 30 and then through hose 7 into a bucket 9 for manual loading into the CNC machine 6 sump or reservoir 8 in premeasured volume and concentrate.

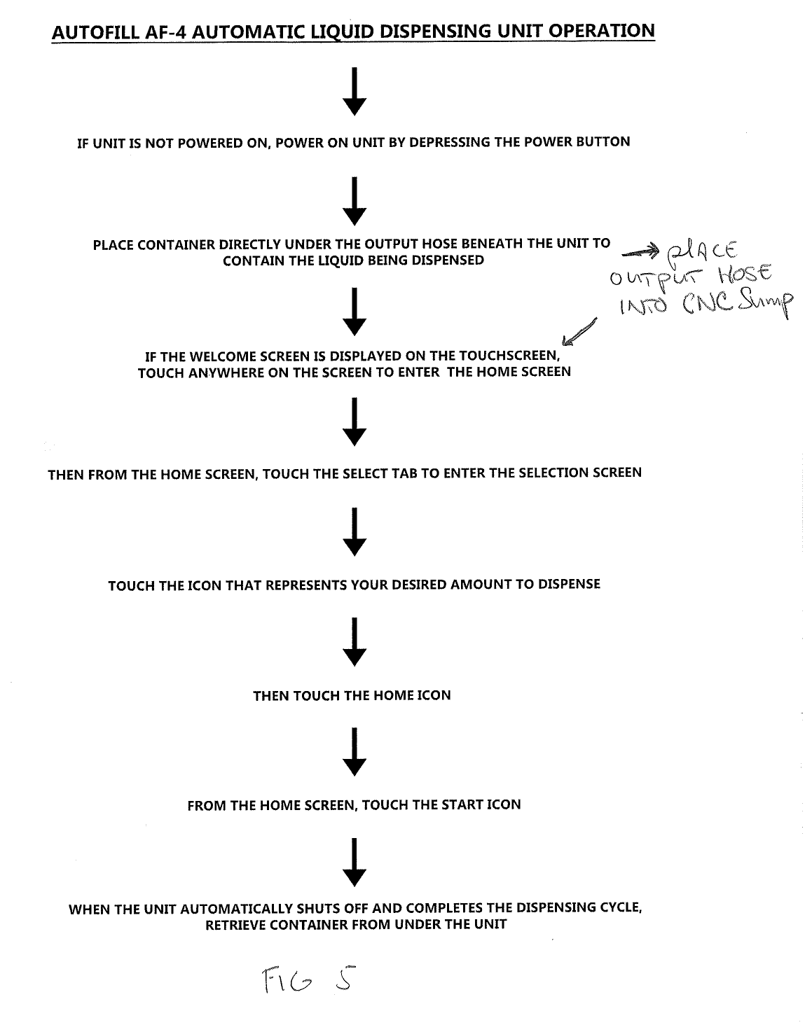

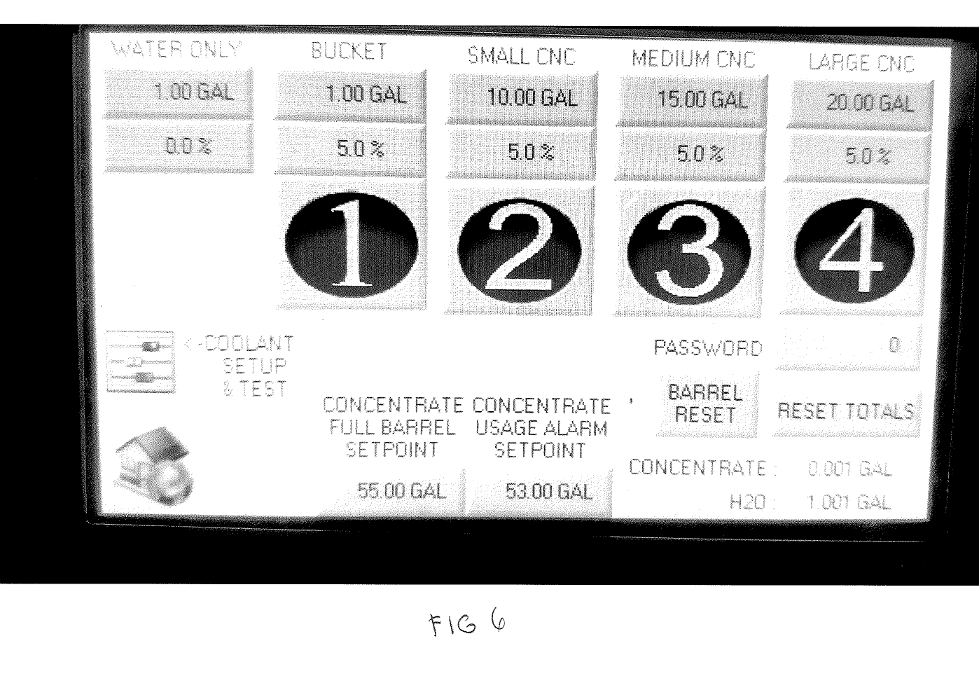

FIG. 5 illustrates the operation flow chart of the dispenser 20 in FIGS. 2 and 3. The touch control 46 of FIG. 6 illustrates options for volume and mixing ratios of the concentrate and water to be chosen by the operator. Illustratively, five pre-set programs may be available for the operator. The top number of each program is the volume to be dispensed and the bottom number of each program is the percentage at which to mix the concentrate into the water. For example, for program 2, if you were to dispense 10 gallons total at a 5% mix ratio, you would dispense ½ gallon of oil on the concentrate side and 9½ gallons of water on water side. The two fluids would come together in the mixing block 30 that hangs below the unit. The fluids are mixed there, then continue into whatever reservoir you are dispensing into, whether it be a bucket 9 or a sump tank 8.

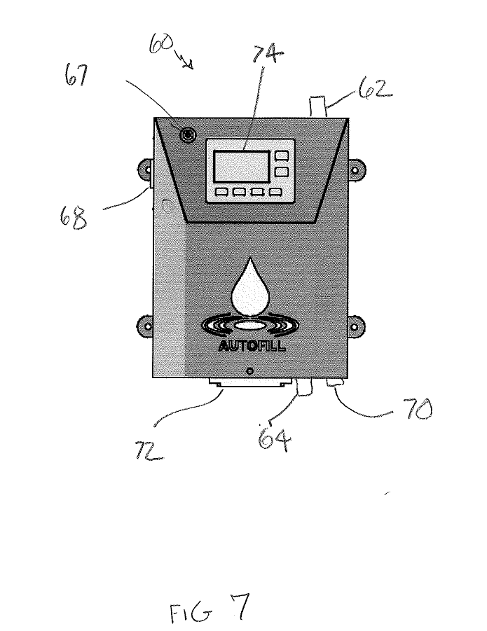

FIGS. 7 and 8 illustrate a second embodiment of a premixed fluid one input adjustable automatic dispensing apparatus or dispenser 60. The dispenser 60 has an internal conduit 61 in flow communication with pre-mixed lubrication concentrate (cutting oil) and water inlet 62 and pre-mixed lubrication concentrate and water outlet 64. Conduit 61 has a solenoid valve 65 and a flow meter 66. The dispenser 60 further has a power button 67, a self-priming pump power outlet 68, fluid source empty buzzer and a bucket light 72. A touch screen control 74 is provided along with a power supply 76 and a relay 78 for energizing a self-priming external pump 3 on the drum 2

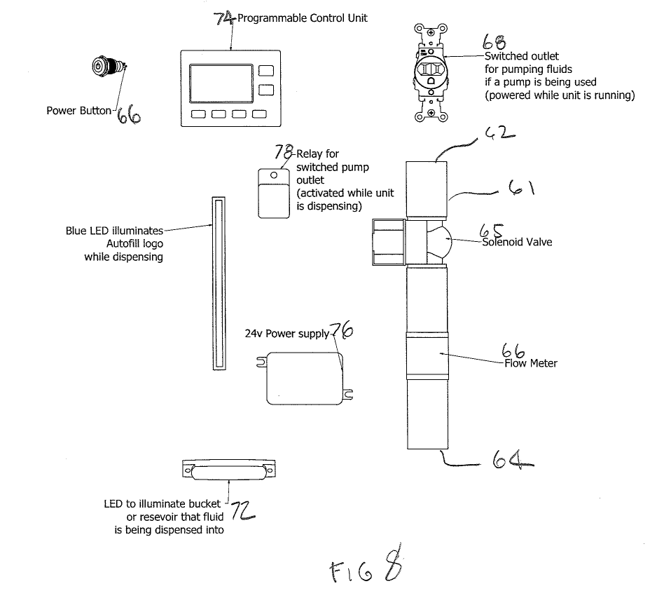

FIG. 9 illustrates the use of the dispenser 60 with a pre-mixed concentrate and water solution with CNC machines 6. Pre-mixed remote solution from a central mixing station is fed to dispensers 60 through conduit 10 into the dispensers' solution input 62. The dispenser 60 is connected to an electrical power source 76. The power button 67 is pushed to energize the dispenser 60 and to turn on the touch screen control 74. The operator puts in the volume of pre-mixed cutting and cooling solution suitably in gallons and presses the run button on the control 74. The solenoid valve 65 opens up to allow flow of the solution while the flow meter 66 counts the volume of fluid passing through the dispenser 60, into pre-mixed solution output 64 into reservoir or machine sump 8 via hose 7 until the desired amount has been delivered when the control 74 closes the solenoid valve 65.

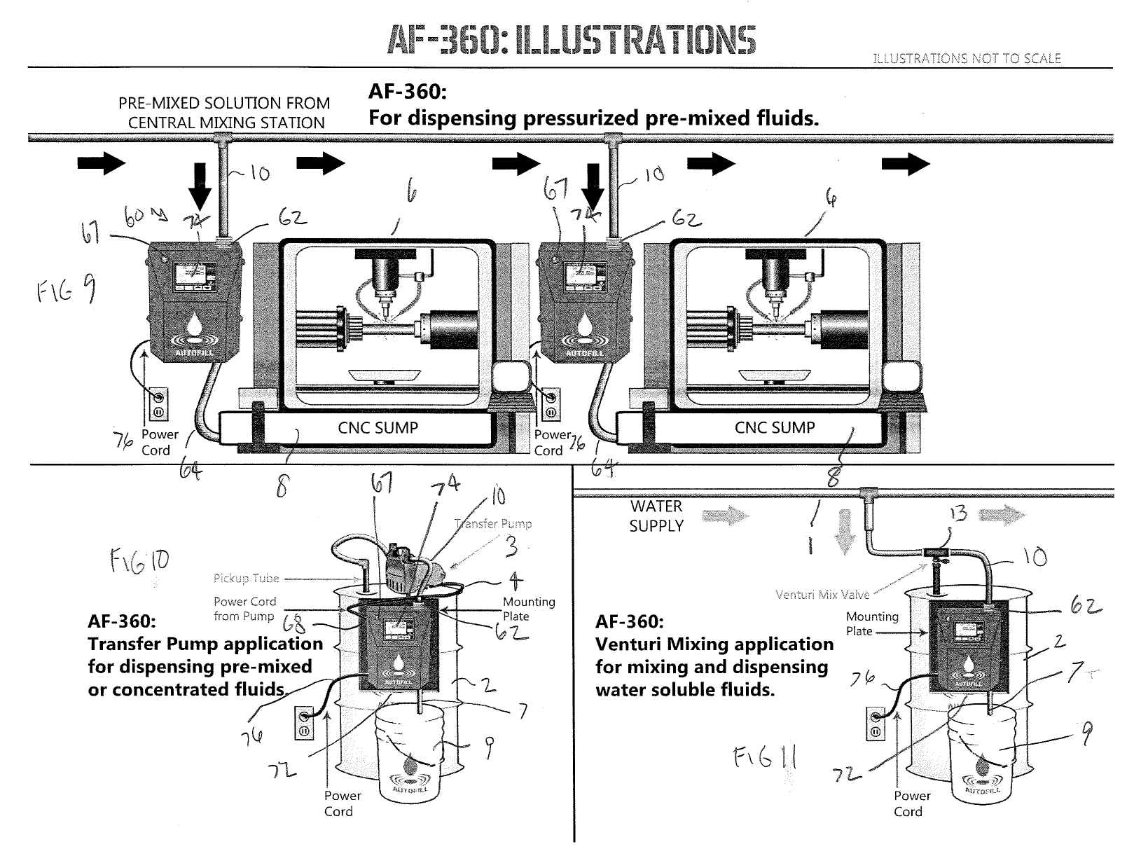

FIG. 10 illustrates the dispenser 60 with a bucket 9 application with an external self-priming pump 3. The drum 2 contains a pre-mixed concentrate and water solution. The dispenser 60 is supplied with electrical power 76. The operator pushes the power button 67 to energize the dispenser 60 and the touch screen control 74 wakes up. The relay 78 energizes the pump 3 through outlet 68. The operator puts in the desired volume of pre-mixed cutting and cooling solution suitably in gallons and presses the run button on the control 74. The solenoid valve 65 opens up to allow flow of the pre-mixed solution while the flow meter 66 counts the volume of fluid passing through the dispenser 60, into pre-mixed solution output 64 into the illuminated bucket 8 via hose 7 until the desired amount has been delivered when the control 74 closes the solenoid valve 65.

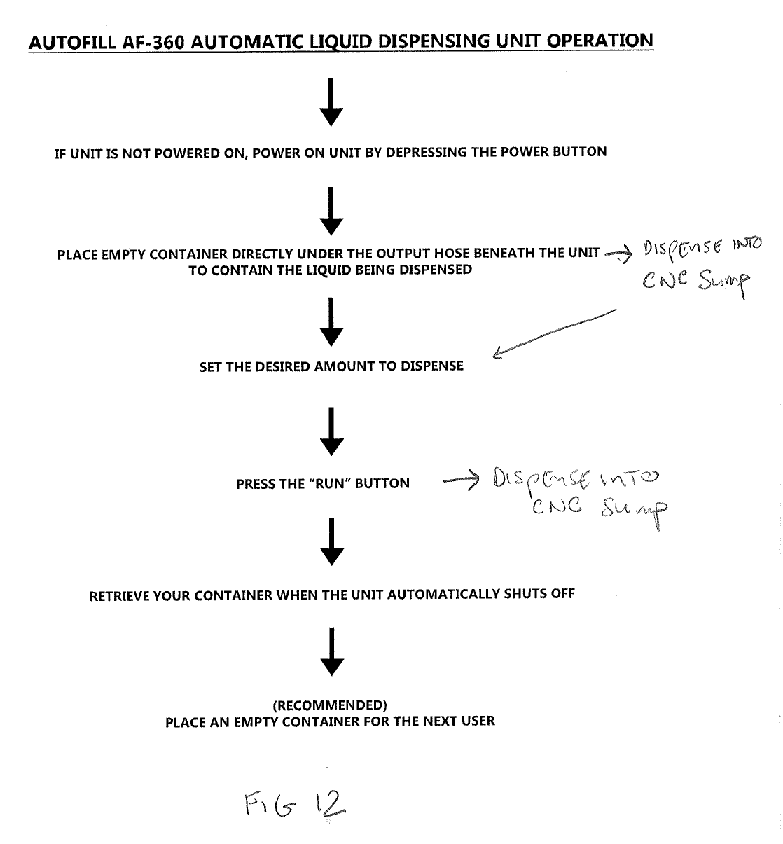

FIG. 11 illustrates the dispenser 60 with a bucket 8 application. A pressurized water supply 1, a pre-mixed drum 2 with mixed solution and a venturi mixing valve 13. The water is connected to the venture valve 13. The dispenser 60 is supplied with electrical power 76. The operator pushes the power button 67 to energize the dispenser 60 and the touch screen control 74 wakes up. The operator puts in the desired volume of pre-mixed cutting and cooling solution suitably in gallons and presses the run button on the control 74. The solenoid valve 65 opens up to allow flow of the pre-mixed solution while the flow meter 66 counts the volume of fluid passing through the dispenser 60, into pre-mixed solution output 64, hose land then into the illuminated bucket 9 until the desired amount has been delivered when the control 74 closes the solenoid valve 65.

FIG. 12 illustrates the operation flow chart of the second embodiment 60 of the premixed fluid one input adjustable automatic dispensing apparatus or dispenser 60.

The present invention is useful is dispensing a variety of fluids that may be mixed with other solutions to include cutting fluids, cleaning fluids, antifreeze, oils, pool chemicals and the like.

The above specification and accompanying drawings are for illustrative purposes only. The true scope of the present invention being defined by the following claims.

What is claimed:

1. An adjustable automatic fluid dispensing apparatus for a fluid, comprising:
(a) an inlet for receiving the fluid to be dispensed;
(b) a flow sensor in flow communication with the inlet for sensing the amount of the fluid that is passing through the inlet;
(c) a solenoid valve in flow communication with the inlet and flow sensor for controlling the flow amount of the fluid passing through the inlet;
(d) an outlet in flow communication with the inlet, solenoid valve and flow sensor for dispensing the fluid out of the apparatus;
(e) a power source; and
(f) a programmable control connected to the flow sensor for adjustably controlling the solenoid valve to dispense a desired settable amount of the fluid from the apparatus.

2. The adjustable automatic fluid dispensing apparatus of claim 1, further comprising a conduit in flow communication with the outlet to direct the fluid flowing out of the apparatus to a desired location.

3. An adjustable automatic fluid dispensing apparatus of claim 1 for dispensing further a second fluid, comprising:
(a) a second inlet for receiving the second fluid to be dispensed;
(b) a second flow sensor in flow communication with the second inlet for sensing the amount of the second fluid that is passing through the second inlet;
(c) a second solenoid valve in flow communication with the second inlet and second flow sensor for controlling the flow amount of the second fluid passing through the second inlet;
(d) a second outlet in flow communication with the second inlet, second solenoid valve and second flow sensor for dispensing the second fluid out of the apparatus;

4. The adjustable automatic fluid dispensing apparatus of claim 3, further comprising a conduit in flow communication with the second outlet to direct the second fluid flowing out of the apparatus to a desired location.

5. An adjustable automatic fluid dispensing apparatus of claim 3, wherein the programmable control unit adjustably controls the second flow sensor and second solenoid valve to dispense a desired settable amount of the second fluid from the apparatus.

6. The adjustable automatic fluid dispensing apparatus of claim 3, further comprising a mixing manifold and the first and second outlets are in flow communication with the mixing manifold for mixing the first and second fluids into one mixed fluid.

7. The adjustable automatic fluid dispensing apparatus of claim 6, further comprising a conduit in flow communication with the first and second outlets and the mixing manifold to direct the mixed fluid flowing out of the apparatus to a desired location.

8. An adjustable automatic first and second fluid mixing and dispensing apparatus for first and second fluids, comprising:
(a) first and second inlets for receiving the first and second fluids to be mixed and dispensed;
(b) first and second flow sensors in flow communication with the first and second inlet for sensing the amount of the first and second fluids that are passing through the first and second inlets;
(c) first and second solenoid valves in flow communication with the first and second inlets and first and second flow sensors for controlling the flow amount of the first and second fluids passing through the first and second inlets;
(d) first and second outlets in flow communication with the first and second inlets, the first and second solenoid valves and the first and second flow sensors for dispensing the first and second fluids together out of the apparatus;
(e) a power source; and
(f) a programmable control connected to the flow sensors and for connected to the flow sensors and for adjustably controlling the solenoid valves to dispense a desired settable amount of the first and second fluids together from the apparatus;

9. The adjustable automatic first and second fluid mixing and dispensing apparatus of claim 8, further comprising a mixing manifold and the first and second outlets are in flow communication with the mixing manifold for mixing the first and second fluids into one mixed fluid for first and second fluids

10. The adjustable automatic first and second fluid mixing and dispensing apparatus of claim 9, further comprising a conduit in flow communication with the mixing manifold to direct the mixed fluid flowing out of the mixing manifold to a desired location.

11. An adjustable automatic first and second fluid mixing and dispensing apparatus for first and second fluids, comprising:
(a) first and second inlets for receiving the first and second fluids to be mixed and dispensed;
(b) first and second flow sensors in flow communication with the first and second inlet for sensing the amount of the first and second fluids that are passing through the first and second inlets;
(c) first and second solenoid valves in flow communication with the first and second inlets and first and second flow sensors for controlling the flow amount of the first and second fluids passing through the first and second inlets;
(d) first and second outlets in flow communication with the first and second inlets, the first and second solenoid valves and the first and second flow sensors for dispensing the first and second fluids out of the apparatus;
(e) a power source;
(f) a programmable control connected to the flow sensors and for connected to the flow sensors and for adjustably controlling the solenoid valves to dispense a desired settable amount of the first and second fluid from the apparatus;
(g) a mixing manifold and the first and second outlets are in flow communication with the mixing manifold for mixing the first and second fluids into one mixed fluid; and
(h) a conduit in flow communication with the mixing manifold to direct the mixed fluid flowing out of the mixing manifold to a desired location.
